(19) United States
(12) Patent Application Publication
(10) Pub. No.: US 2021/0096434 A1
(43) Pub. Date: Apr. 1, 2021

(54) DISPLAY DEVICE

(71) Applicant: ELECTRONICS AND TELECOMMUNICATIONS RESEARCH INSTITUTE, Daejeon (KR)

(72) Inventors: Ji Hun CHOI, Daejeon (KR); Yong Hae KIM, Daejeon (KR); Seong-Mok CHO, Daejeon (KR); Chi-Sun HWANG, Daejeon (KR)

(73) Assignee: ELECTRONICS AND TELECOMMUNICATIONS RESEARCH INSTITUTE, Daejeon (KR)

(21) Appl. No.: 16/987,982

(22) Filed: Aug. 7, 2020

(30) Foreign Application Priority Data
Sep. 27, 2019 (KR) 10-2019-0119626

(51) Int. Cl. G02F 1/1362; G02F 1/1335

(52) U.S. Cl. CPC G02F 1/136286; G02F 1/133526; G02F 1/133553

(57) ABSTRACT

Provided is a display device. The display device includes first to second gate lines provided on a substrate having first and second pixel areas and extending in a first direction, first to third data lines extending in a second direction perpendicular to the first direction and intersecting the first to second gate lines, and a first reflective electrode provided inside the first pixel area and a second reflective electrode provided inside the second pixel area, from a planar viewpoint, wherein the first to second gate lines and the first to third data lines define the first pixel area and the second pixel area, wherein the first to second gate lines are spaced apart from each other in the second direction, wherein the first to third data lines are spaced apart from each other in the first direction.

### CROSS-REFERENCE TO RELATED APPLICATIONS

This U.S. non-provisional patent application claims priority under 35 U.S.C. § 119 of Korean Patent Application No. 10-2019-0119626, filed on Sep. 27, 2019, the entire contents of which are hereby incorporated by reference.

### BACKGROUND

The present disclosure herein relates to a display device, and more particularly to a display device having a wide viewing angle.

As display devices are applied to various fields, there is a growing demand for the quality improvement of the display devices. Recently, a hologram display device using a high resolution panel has been developed, but its technology maturity is weak compared to a conventional display device. In order to develop a high-quality hologram display device, development of a display panel having a high resolution and a wide viewing angle should be prioritized. The resolution and viewing angle of the display panel are related to the pitch of the pixels. Recently, research has been actively conducted to reduce the pitch of pixels of a display device.

### SUMMARY

The present disclosure provides a display device having improved resolution and a wide viewing angle.

An embodiment of the inventive concept provides a display device including: first to second gate lines provided on a substrate having first and second pixel areas and extending in a first direction; first to third data lines extending in a second direction perpendicular to the first direction and intersecting the first to second gate lines; and a first reflective electrode provided inside the first pixel area and a second reflective electrode provided inside the second pixel area, from a planar viewpoint, wherein the first to second gate lines and the first to third data lines define the first pixel area and the second pixel area, wherein the first to second gate lines are spaced apart from each other in the second direction, wherein the first to third data lines are spaced apart from each other in the first direction, wherein a distance in which the first reflective electrode is spaced apart from the first gate line in the second direction is different from a distance in which the second reflective electrode is spaced apart from the first gate line in the second direction.

In an embodiment, a distance in which the first reflective electrode is spaced apart from the first data line in the first direction may be different from a distance in which the second reflective electrode is spaced apart from the second data line in the first direction.

In an embodiment, the display device may further include: a first flat layer interposed between the substrate and the first reflective electrode and between the substrate and the second reflective electrode; a first lens configured to cover the first reflective electrode on the first flat layer; and a second lens configured to cover the second reflective electrode on the first flat layer.

In an embodiment, the first lens may be vertically aligned with the first reflective electrode, wherein the second lens may be vertically aligned with the second reflective electrode.

In an embodiment, a diameter of the first lens may be larger than a width of the first reflective electrode, wherein a diameter of the second lens may be larger than a width of the second reflective electrode.

In an embodiment, the display device may further include: a second flat layer configured to cover the first lens and the second lens on the first flat layer; and a first auxiliary lens and a second auxiliary lens provided on an upper surface of the second flat layer.

In an embodiment, from a planar viewpoint, a center of the first lens may coincide with a center of the first auxiliary lens.

In an embodiment, the first auxiliary lens may be vertically aligned with the first lens, wherein the second auxiliary lens may be vertically aligned with the second lens.

In an embodiment, a diameter of the first auxiliary lens may be smaller than a width of the first reflective electrode, wherein a diameter of the second auxiliary lens may be smaller than a width of the second reflective electrode.

In an embodiment, a diameter of the first auxiliary lens may be smaller than a diameter of the first lens.

In an embodiment of the inventive concept, a display device includes: gate lines provided on a substrate having a plurality of pixel areas and extending in a first direction, from a planar viewpoint; data lines extending in a second direction perpendicular to the first direction and intersecting the gate lines; reflective electrodes provided inside the pixel areas, respectively; lenses provided on the reflective electrodes, respectively; and auxiliary lenses provided on the lenses, respectively, wherein the gate lines and the data lines define the pixel areas, wherein the lenses cover the reflective electrodes, respectively, wherein the auxiliary lenses are vertically aligned with the lenses, respectively.

In an embodiment, diameters of the lenses may be larger than widths of the reflective electrodes, respectively.

In an embodiment, diameters of the auxiliary lenses may be smaller than diameters of the lenses, respectively.

In an embodiment, the reflective electrodes may be spaced apart from the data lines in the first direction, wherein the reflective electrodes may be spaced apart from the gate lines in the second direction, wherein a distance in which one of the reflective electrodes is spaced apart from one of the data lines in the first direction may be different from a distance in which another of the reflective electrodes is spaced apart from another of the data lines in the first direction.

In an embodiment, a distance in which one of the reflective electrodes is spaced apart from one of the gate lines in the second direction may be different from a distance in which another of the reflective electrodes is spaced apart from another of the gate lines in the second direction.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a schematic block diagram of a display device according to embodiments of the inventive concept;

FIG. 2 is an equivalent circuit diagram of a display device according to embodiments of the inventive concept;

FIG. 3 is a plan view illustrating a display device according to embodiments of the inventive concept;

FIG. 4 is a plan view illustrating a display device according to embodiments of the inventive concept;

FIG. 5A is a cross-sectional view taken along line I-I′ of FIG. 3;

FIG. 5B is a cross-sectional view taken along line II-IP shown in FIG. 3; and

FIG. 6 is a graph showing a correlation between a pixel pitch and a viewing angle.

### DETAILED DESCRIPTION

Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Further, the inventive concept is only defined by scopes of claims. Like reference numbers refer to like elements throughout the entire specification.

The terms used in this specification are used only for explaining specific embodiments while not limiting the inventive concept. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Additionally, embodiments described in this specification will be described with plan views sectional views, that is, ideal exemplary views of the inventive concept. In the drawings, the thicknesses of a layer and an area are exaggerated for effective description. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. For example, an etched region illustrated as a rectangle may have rounded or curved features. Areas exemplified in the drawings have general properties, and are used to illustrate a specific shape of a semiconductor package region. Thus, this should not be construed as limited to the scope of the inventive concept.

Hereinafter, embodiments of the inventive concept will be described in detail with reference to the drawings.

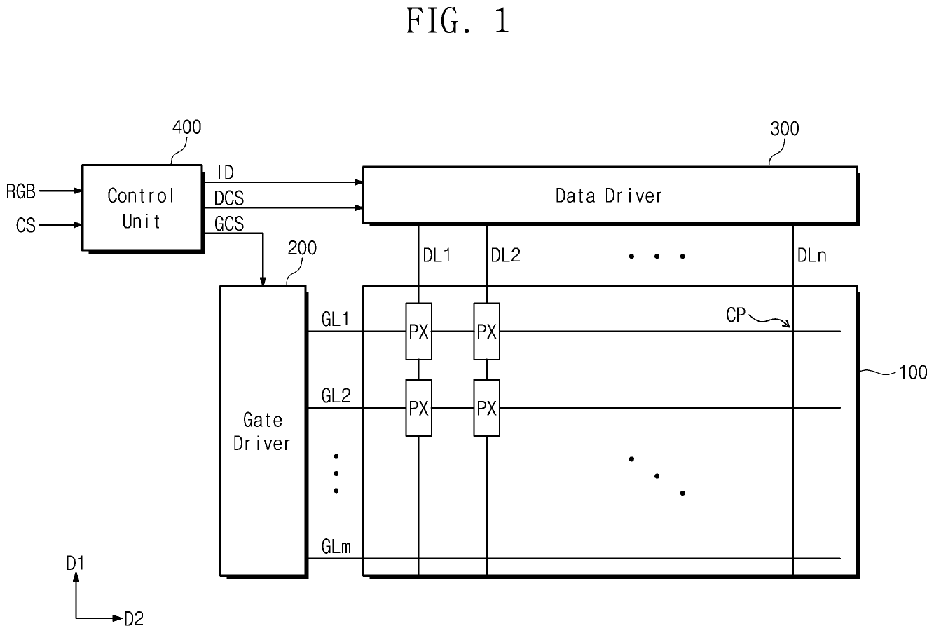

FIG. 1 is a schematic block diagram of a display device according to embodiments of the inventive concept.

Referring to FIG. 1, a display device according to embodiments of the inventive concept may include a control unit 400, a gate driver 200, a data driver 300, and a display panel 100. The control unit 400 may drive the gate driver 200 and the data driver 300. The gate driver 200 and the data driver 300 may drive the display panel 100.

The control unit 400 may receive input image data RGB and control signals CS from the outside of the display device. The control unit 400 may convert the received input image data RGB to generate image data ID. For example, converting the received input image data RGB may include converting the data format of the input image data RGB according to the interface specification of the data driver 300. The control unit 400 may provide the image data ID to the data driver 300.

The control unit 400 may generate the data control signal DCS and the gate control signal CS based on the received control signal CS. The gate control signal CS may include, for example, a vertical start signal, a vertical clock signal, and a vertical clock bar signal. The control unit 400 may provide the data control signal CS to the data driver 300. The control unit 400 may provide the gate control signal CS to the gate driver 200.

The gate driver 200 may sequentially output the gate signals in response to the gate control signal CS provided from the control unit 400. The data driver 300 converts the image data ID into data voltages and outputs the data voltages in response to the data control signal DCS provided from the control unit 400. The outputted data voltages may be applied to the display panel 100.

The display panel 100 may include gate lines GL1, GL2, and GLm, data lines DL1, DL2, and DLn, and pixel areas PX. The gate lines GL1, GL2, and GLm may receive gate signals from the gate driver 200. The data lines DL1, DL2, and DLn may receive the data voltage from the data driver 300. The gate lines GL1, GL2, and GLm may be insulated from and intersect with the data lines DL1, DL2, and DLn.

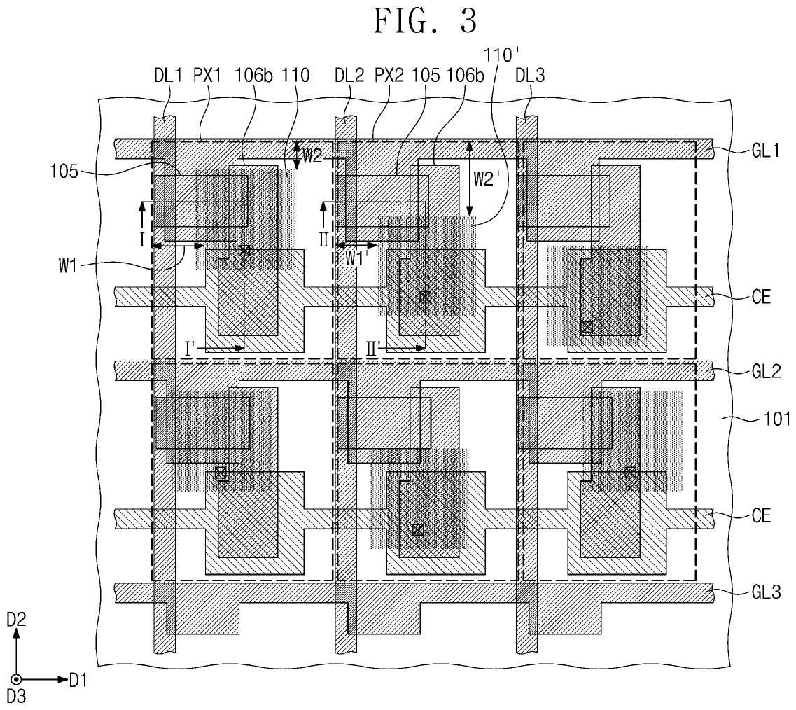

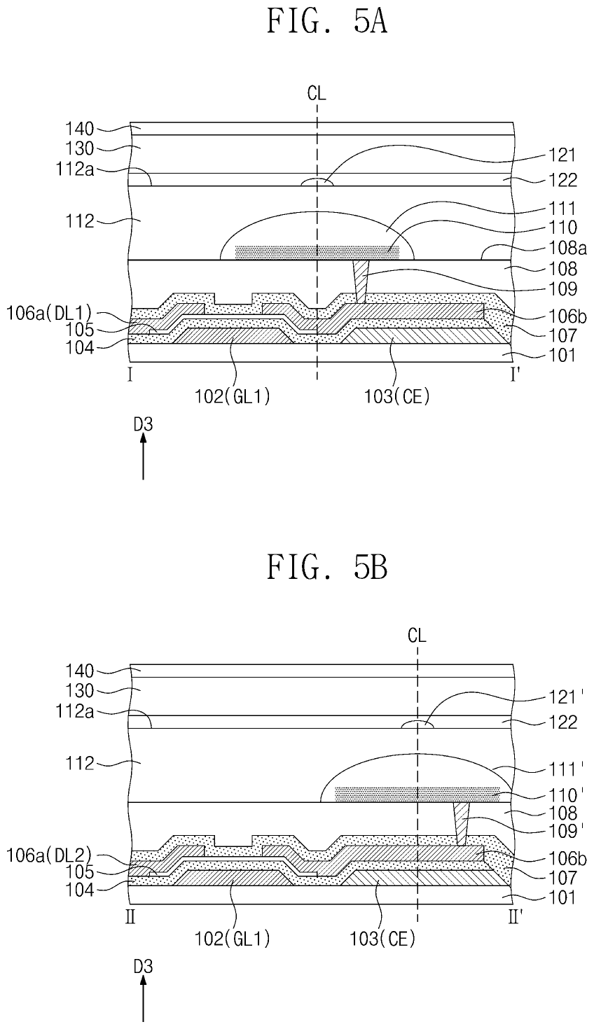

The pixel areas PX may be connected to a corresponding one of the data lines DL1 to DLm and may be connected to a corresponding one of the gate lines GL1 to GLn. The pixel areas PX may display the primary color. Each of the pixel areas PX may display, for example, any one of red, green, and blue. However, the colors that the pixel areas PX may display are not limited thereto. Each of the pixel areas PX may display one of red, green, and blue colors. The pixel areas PX may be arranged in the form of a two-dimensional matrix in the display panel 100. The pixel areas PX may be an area for displaying a unit image constituting an image. In other words, the resolution of the display panel 100 may be determined according to the number of the pixel areas PX included in the display panel 100. In FIG. 1, only a part of the pixel areas PX is shown, and the rest are omitted. The pixel areas PX may be formed by overlapping the intersection points CP of the gate lines GL1, GL2, and GLm and the data lines DL1, DL2, and DLn. In this specification, an intersection point CP may refer to a portion where the gate lines GL1, GL2, and GLm and the data lines DL1, DL2, and DLn intersect with each other in plan view. A more specific structure of the pixel areas PX, the gate lines GL1, GL2, and GLm, and the data lines DL1, DL2, and DLn will be described with reference to FIGS. 3, 5A, and 5B.

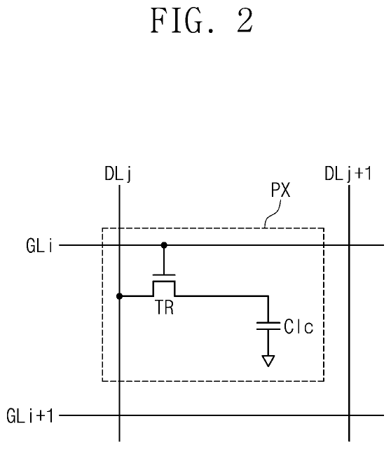

FIG. 2 is an equivalent circuit diagram of a display device according to embodiments of the inventive concept.

As shown in FIG. 2, each of the pixel areas PX may include a transistor TR and a capacitor Clc. The transistor TR may be electrically connected to the i-th gate line GLi and the j-th data line DLj. The transistor TR may output a data signal received from the j-th data line DLj in response to the gate signal received from the i-th gate line GLi. The capacitor Clc may charge the voltage corresponding to the data signal outputted from the j-th data line DLj.

FIG. 3 is a plan view illustrating a display device according to embodiments of the inventive concept.

Referring to FIG. 3, a display device according to an embodiment of the inventive concept may include a substrate 101 having a plurality of pixel areas PX, a plurality of data lines DL1, DL2, and DL3 provided on the substrate 101, and a plurality of gate lines GL1, GL2, and GL3 intersecting the data lines DL1, DL2, and DL3. The substrate 101 may include a silicon substrate or a glass substrate having a flat upper surface. The substrate 101 may have a plurality of pixel areas PX. The first direction D1 may be a direction parallel to the upper surface of the substrate 101. The second direction D2 may be parallel to the upper surface of the substrate 101 and perpendicular to the first direction D1. The third direction D3 may be a direction perpendicular to the upper surface of the substrate 101 and perpendicular to the first direction D1 and the second direction D2.

The data lines DL1, DL2, and DL3 may be provided on the substrate 101. The data lines DL1, DL2, and DL3 may extend in the second direction D2. The data lines DL1, DL2, and DL3 may be arranged spaced apart from each other in the first direction D1. The separation distances between the data lines DL1, DL2, and DL3 may be the same. The data lines DL1, DL2, and DL3 may be electrically separated from the gator lines GL1, GL2, and GL3. The data lines DL1, DL2, and DL3 may include a conductive material. The data lines DL1, DL2, and DL3 may include, for example, copper (Cu), molybdenum (Mo), aluminum (Al), titanium (Ti), aluminum-nickel (Al—Ni) alloy, Cu alloy, Mo alloy, and Al alloy. The data lines DL1, DL2, and DL3 may deliver a data signal to the transistor TR. The data lines DL1, DL2, and DL3 may be part of the data lines DL1 to DLm described with reference to FIG. 1. More specifically, the data lines DL1, DL2, and DL3 may include a first data line DL1, a second data line DL2, and a third data line DL3.

The gate lines GL1, GL2, and GL3 may be provided on the substrate 101. The gate lines GL1, GL2, and GL3 may extend in the first direction D1. The gate lines GL1, GL2, and GL3 may be arranged spaced apart from each other in the second direction D2. The separation distance between the gate lines GL1, GL2, and GL3 may be the same. The gate lines GL1, GL2, and GL3 may be electrically separated from the data lines DL1, DL2, and DL3. The gate lines GL1, GL2, and GL3 may include the same material as the data lines DL1, DL2, and DL3. The gate lines GL1, GL2, and GL3 may deliver a gate signal to the transistor TR. The gate lines GL1, GL2, and GL3 may be part of the gate lines GL1 to GLn described with reference to FIG. 1. More specifically, the gate lines GL1, GL2, and GL3 may include a first gate line GL1, a second gate line GL2, and a third gate line GL3.

The substrate 101 may have a plurality of pixel areas PX. The plurality of pixel areas may include a first pixel area PX1 and a second pixel area PX2. Hereinafter, the first pixel region PX1 and the second pixel region PX2 adjacent to each other will be described.

The first pixel area PX1 may be provided on the substrate. The first pixel area PX1 may be defined by a first gate line GL1, a second gate line GL2, a first data line DL1, and a second data line DL2. For example, a separation distance between the first gate line GL1 and the second gate line GL2 from a planar viewpoint may define a vertical width of the first pixel area PX1. The separation distance between the first data line DL1 and the second data line DL2 may define a horizontal width of the first pixel area PX1. The first pixel area PX1 may be formed by overlapping at least a part of a portion where the first gate line GL1 and the first data line DL1 intersect.

The second pixel area PX2 may be provided on a substrate adjacent to the first pixel area PX1. The second pixel area PX2 may be defined by a first gate line GL1, a second gate line GL2, a second data line DL2, and a third data line DL3. For example, a separation distance between the first gate line GL1 and the second gate line GL2 may define a vertical width of the second pixel area PX2. The separation distance between the second data line DL2 and the third data line DL3 may define a horizontal width of the second pixel area PX2. The second pixel area PX2 may be formed by overlapping at least a part of a portion where the first gate line GL1 and the second data line DL2 intersect.

From a planar viewpoint, the first reflective electrode 110 and the second reflective electrode 110′ may be provided inside the first pixel area PX1 and the second pixel area PX2, respectively. For example, the first reflective electrode 110 and the second reflective electrode 110′ may have a quadrangular shape. However, the first reflective electrode 110 and the second reflective electrode 110′ are not limited thereto, and may be variously modified in a polygonal shape and/or a circular shape. The first reflective electrode 110 may be spaced apart from the first gate line GL1 in the opposite direction to the second direction D2. The first reflective electrode 110 may be spaced apart from the first data line DL1 in the first direction D1. The second reflective electrode 110′ may be spaced apart from the first gate line GL1 in a direction opposite to the second direction D2. The second reflective electrode 110′ may be spaced apart from the second data line DL2 in the first direction D1. The distance W1 in which the first reflective electrode 110 is spaced apart from the first data line DL1 in the first direction D1 may be different from the distance W1′ in which the second reflective electrode 110′ is spaced apart from the second data line DL2 in the first direction D1. The distance W2 in which the first reflective electrode 110 is spaced apart from the first gate line GL1 in the opposite direction to the second direction D2 may be different from the distance W2′ in which the second reflective electrode 110′ is spaced apart from the first gate line GL1 in the opposite direction of the second direction D2. Accordingly, the first reflective electrode 110 and the second reflective electrode 110′ may not be aligned in the first direction D1 or the second direction D2. From a planar viewpoint, the first reflective electrode 110 and the second reflective electrode 110′ may overlap the data lines DL1, DL2, and DL3 or the gate lines GL1, GL2, and GL3. The first reflective electrode 110 and the second reflective electrode 110′ may be spaced apart from each other in the first direction D1 and/or the second direction D2. Unlike the drawing shown, a portion of the first reflective electrode 110 may escape the first pixel region PX1, and a portion of the second reflective electrode 110′ may escape the second pixel region PX2.

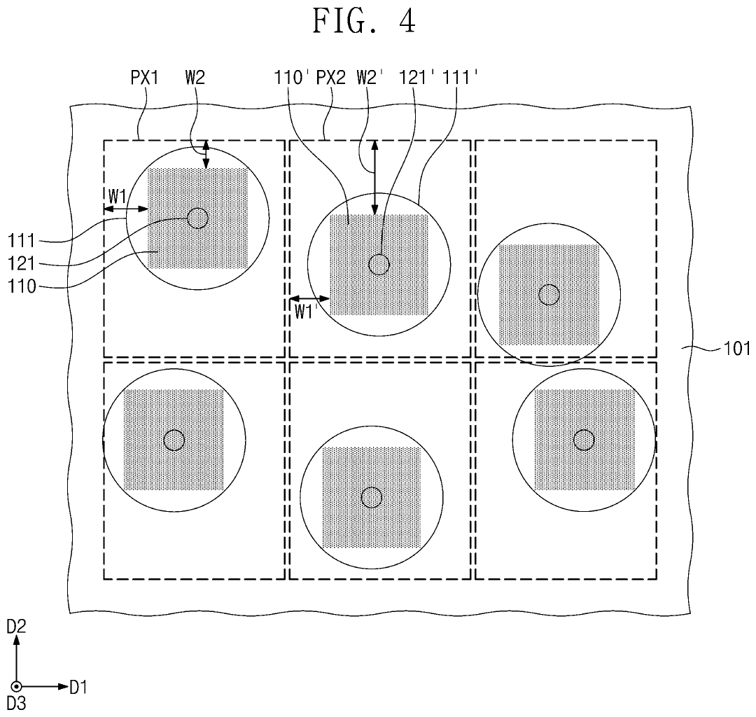

FIG. 4 is a plan view illustrating a display device according to embodiments of the inventive concept. FIG. 5A is a cross-sectional view taken along line I-I′ of FIG. 3. Hereinafter, the description will be omitted in the range overlapping with the above-described content.

Referring to FIGS. 3, 4, and 5A, the first pixel area PX1 may include a transistor TR, a capacitor Clc, a first reflective electrode 110, a first lens 111, a first auxiliary lens 121, a first flat layer 108, a second flat layer 112, a third flat layer 122, and a liquid crystal layer 130.

The transistor TR may be provided on the substrate 101. The transistor TR may include a first electrode 106a, a second electrode 106b, a gate electrode 102, a gate insulating film 104, and a semiconductor layer 105. The transistor TR may be a thin film transistor.

The first electrode 106a may be a drain electrode or a source electrode. The second electrode 106b may be a drain electrode or a source electrode that is different from the first electrode 106a. For example, when the first electrode 106a is a drain electrode, the second electrode 106b may be a source electrode, and when the first electrode 106a is a source electrode, the second electrode 106b may be a drain electrode. The first electrode 106a and the second electrode 106b may include metal. The first electrode 106a and the second electrode 106b may include the same material as the data lines DL1, DL2, and DL3. The first electrode 106a may be part of the first data line DL1. The first electrode 106a may receive a data signal from the first data line DL1. From the planar viewpoint, the second electrode 106b is spaced apart from the first data line DL1 in the first direction D1 and may extend in a direction opposite to the second direction D2. The second electrode 106b may be electrically connected to the first reflective electrode 110 through the first via 109. The second electrode 106b may apply a data voltage to the reflective electrode 110 through the first via 109. Accordingly, the first reflective electrode 110 may form an electric field with the second common electrode 140.

The semiconductor layer 105 may be disposed between the first electrode 106a and the second electrode 106b. The semiconductor layer 105 may connect the first electrode 106a and the second electrode 106b. More specifically, a portion of the semiconductor layer 105 may be connected to the first electrode 106a, and another portion of the semiconductor layer 105 may be connected to the second electrode 106b. The semiconductor layer 105 may be formed on the gate electrode 102 and the gate insulating film 104. The semiconductor layer 105 may include amorphous silicon, low temperature polysilicon, or a metal oxide. The semiconductor layer 105 may include a channel area that forms a conductive channel between the first electrode 106a and the second electrode 106b depending on whether a voltage is applied to the gate electrode 102.

The gate electrode 102 may be interposed between the substrate 101 and the first electrode 106a and the second electrode 106b. The gate electrode 102 may be part of the first gate line GL1. A gate insulating film 104 may be interposed between the gate electrode 102 and the semiconductor layer 105. The gate insulating layer 104 may include silicon oxide (SiOx) or silicon nitride (SiNx). The gate insulating film 104 may conformally cover the gate electrode 102 and the first common electrode 103. The passivation layer 107 may conformally cover the first electrode 106a, the second electrode 106b, and the semiconductor layer 105 exposed by the first electrode 106a and the second electrode 106b. The passivation layer 107 may function as a protective film for protecting the transistor TR.

The capacitor Clc may be provided on the substrate 101. The capacitor Clc may include a first common electrode 103, a second electrode 106b, and a gate insulating film 104. The first common electrode 103 may be interposed between the second electrode 106b and the substrate 101. The capacitor Clc may output the data signal received from the first data line DL1 in response to the gate signal received from the gate electrode 102. The capacitor Clc may charge the data voltage corresponding to the data signal outputted from the first data line DL1.

A first flat layer 108 can be provided on the passivation layer 107. The first flat layer 108 may have a flat upper surface 108a. The first flat layer 108 may be formed entirely on the substrate 101. The first reflective electrode 110 may be provided on the upper surface 108a of the first flat layer 108. The first reflective electrode 110 may be opaque and have a large optical thickness. The first reflective electrode 110 may include, for example, silver (Ag), magnesium (Mg), aluminum (Al), platinum (Pt), palladium (Pd), gold (Au), nickel (Ni), neodymium (Nd), Iridium (Ir), chromium (Cr), lithium (Li), calcium (Ca), molybdenum (Mo), titanium (Ti) and/or compounds or mixtures thereof. The upper surface of the first reflective electrode 110 may reflect incident light through the second common electrode 140 and the liquid crystal layer 130 from the outside of the display device. The upper surface of the first reflective electrode 110 may have, for example, a flat shape. However, the inventive concept is not limited thereto, and the upper surface of the first reflective electrode 110 may have a concavo-convex shape to reflect incident light at various angles.

The first via 109 may be interposed between the first reflective electrode 110 and the second electrode 106b. The first via 109 may be spaced apart from the center line CL in one direction from a vertical viewpoint. The first via 109 may overlap the second electrode 106b from a planar viewpoint. The first via 109 may penetrate the first flat layer 108 and the passivation layer 107 to electrically connect the first reflective electrode 110 and the second electrode 106b. More specifically, one end of the first via 109 may be connected to the first reflective electrode 110, and the other end of the first via 109 may be connected to the second electrode 106b. The other end of the first via 109 may be connected to a portion adjacent to the gate electrode 102 at the second electrode 106b. Accordingly, the data voltage charged in the capacitor Clc may be applied to the first reflective electrode 110.

The first lens 111 may be provided on the upper surface 108a of the first flat layer 108 and the first reflective electrode 110. More specifically, the first lens 111 may cover the upper surface and side surfaces of the first reflective electrode 110. The diameter of the first lens 111 may be larger than the width of the first reflective electrode 110. From the vertical viewpoint, the center point of the lower surface of the first lens 111 may be aligned with the center point of the lower surface of the first reflective electrode 110. For example, the first lens and the first reflective electrode 110 may be aligned along the center line CL. As illustrated in FIG. 4, the first lens 111 may overlap the first reflective electrode 110 from a planar viewpoint. The first lens 111 may include a polymer material. For example, the first lens 111 may include PDMS. The first lens 111 may be formed through a method such as inkjet printing, laser catapulting (LCP), and patterning using UV. The first lens 111 may collect light reflected through the first reflective electrode 110. The light collected through the first lens 111 may be directed to the first auxiliary lens 121.

A second flat layer 112 may be provided on the first lens 111 and the first flat layer 108. The second flat layer 112 may cover the upper surfaces of the first lens 111 and the first flat layer 108. The upper surface 112a of the second flat layer 112 may be flat. A first auxiliary lens 121 may be provided on the upper surface 112a of the second flat layer 112. The diameter of the first auxiliary lens 121 may be smaller than the diameter of the first lens 111. The diameter of the first auxiliary lens 121 may be smaller than the width of the first reflective electrode 110. From the vertical viewpoint, the first auxiliary lens 121 may overlap the first lens 111. More specifically, the center of the first auxiliary lens 121 may be aligned with the center of the first lens 111. Accordingly, the first auxiliary lens 121, the first lens 111, and the first reflective electrode 110 may be aligned along the center line CL. The first auxiliary lens 121 may include the same material as the first lens 111. The first auxiliary lens 121 may be formed using the same method as the first lens 111. As shown in FIG. 4, from the planar viewpoint, the first auxiliary lens 121 may overlap the first lens 111. More specifically, from the planar viewpoint, the first auxiliary lens 121 may be disposed inside the first lens 111. From the planar viewpoint, the center of the first auxiliary lens 121 may coincide with the center of the first lens 111. The first auxiliary lens 121 may be spaced apart from the second auxiliary lens 121′ of the second pixel area PX2 in a first direction D1 and/or a second direction D2. Accordingly, the first auxiliary lens 121 may not overlap the second auxiliary lens 121′. The first auxiliary lens 121 may serve to collect light passing through the first lens 111 in a narrower width. Since the first auxiliary lens 121 is a portion that substantially emits light in the first pixel area PX1, when the first auxiliary lens 121 collects light received from the first lens 111 in a narrow width, the area in which the unit image is displayed in the panel 100 may be small, so that the resolution of the display panel 100 may be improved.

A third flat layer 122 may be provided on the first auxiliary lens 121 and the second flat layer 112. The third flat layer 122 may cover the upper surfaces of the first auxiliary lens 121 and the second flat layer 112. The upper surface of the third flat layer 122 may be flat. The second common electrode 140 may be provided on the upper surface of the third flat layer 122. The second common electrode 140 may be disposed parallel to the upper surface of the first reflective electrode 110. The second common electrode 140 may be transparent or translucent. The second common electrode 140 may have a smaller optical thickness than the first reflective electrode 110. The second common electrode 140 may include, for example, lithium (Li), calcium (Ca), magnesium (Mg), aluminum (Al), barium fluoride (BaF), barium (Ba), silver (Ag) or a compound or mixture thereof. When the second common electrode 140 is transparent, the second common electrode 140 may include indium tin oxide (ITO), indium zinc oxide (IZO), zinc oxide (ZnO) and/or indium tin zinc oxide (ITZO).

The liquid crystal layer 130 may be provided on the third flat layer 122. More specifically, the liquid crystal layer 130 may be interposed between the first reflective electrode 110 and the second common electrode 140. The liquid crystal layer 130 may include a plurality of liquid crystal directors having dielectric anisotropy. When an electric field is applied between the first reflective electrode 110 and the second common electrode 140, the liquid crystal directors of the liquid crystal layer 130 may rotate in a specific direction to deflect light passing through the liquid crystal layer 130. In addition, the liquid crystal layer 130 may selectively transmit light deflected in a specific direction. Light incident from the outside of the display device toward the first reflective electrode 110 may be absorbed by the liquid crystal layer 130 or reflected by the first reflective electrode 110 according to the electric field applied between the first reflective electrode 110 and the second common electrode 140.

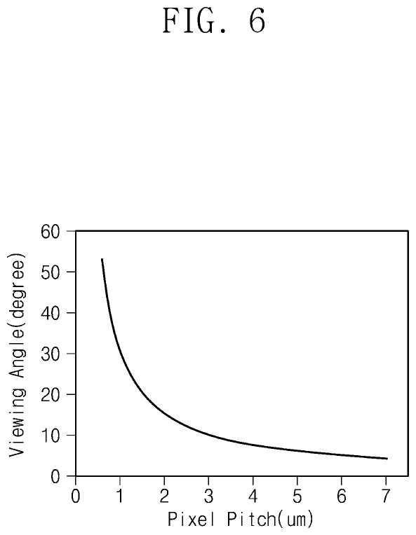

FIG. 5B is a cross-sectional view taken along line II-IP shown in FIG. 3. FIG. 6 is a graph showing a correlation between a pixel pitch and a viewing angle.

Referring to FIG. 5B, the second pixel area PX2 may include a transistor TR, a capacitor Clc, a second reflective electrode 110′, a second lens 111′, a second auxiliary lens 121′, a first flat layer 108, a second flat layer 112, a third flat layer 122, and a liquid crystal layer 130. The transistor TR, the capacitor Clc, the first flat layer 108, the second flat layer 112, the third flat layer 122, and the liquid crystal layer 130 of the second pixel region PX2 may be substantially the same as the content described with reference to FIG. 5A. Therefore, the description is omitted in a range overlapping with the above-described content.

The second via 109′ may be interposed between the second reflective electrode 110′ and the second electrode 106b. The second via 109′ may penetrate the first flat layer 108 and the passivation layer 107 to electrically connect the second reflective electrode 110′ and the second electrode 106b. More specifically, one end of the second via 109′ may be connected to the second reflective electrode 110′, and the other end of the second via 109′ may be connected to the second electrode 106b. The other end of the second via 109′ may be connected to a portion of the second electrode 106b that is not adjacent to the gate electrode 102. Accordingly, the data voltage charged in the capacitor Clc may be applied to the second reflective electrode 110′.

In the display device according to the exemplary embodiments of the inventive concept, reflective electrodes in pixel areas may be arranged in a disorderly manner from a planar viewpoint. Reflective electrodes and auxiliary lenses are aligned from a vertical viewpoint, so auxiliary lenses can also be placed in disorder. Since the auxiliary lenses are actually the part that emits light from the panel, when the distance between auxiliary lenses is closely arranged, the same effect can be achieved as the pitch between pixels is reduced. When the display panel is a hologram panel, as the pitch between pixel regions decreases as shown in FIG. 6, a wide viewing angle may be obtained. Accordingly, as compared to the case where reflective electrodes, lenses, and auxiliary lenses are arranged in a disorderly manner and are regularly spaced apart, the display device according to embodiments of the inventive concept may have a wide viewing angle.

In the display device according to the exemplary embodiments of the inventive concept, reflective electrodes in pixel areas may be arranged in a disorderly manner from a planar viewpoint. Accordingly, it is possible to provide a display device having a wider viewing angle than when reflective electrodes are regularly arranged.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A display device comprising:
first to second gate lines provided on a substrate having first and second pixel areas and extending in a first direction;
first to third data lines extending in a second direction perpendicular to the first direction and intersecting the first to second gate lines; and
a first reflective electrode provided inside the first pixel area and a second reflective electrode provided inside the second pixel area, from a planar viewpoint,
wherein the first to second gate lines and the first to third data lines define the first pixel area and the second pixel area,
wherein the first to second gate lines are spaced apart from each other in the second direction,
wherein the first to third data lines are spaced apart from each other in the first direction,
wherein a distance in which the first reflective electrode is spaced apart from the first gate line in the second direction is different from a distance in which the second reflective electrode is spaced apart from the first gate line in the second direction.

2. The display device of claim 1, wherein a distance in which the first reflective electrode is spaced apart from the first data line in the first direction is different from a distance in which the second reflective electrode is spaced apart from the second data line in the first direction.

3. The display device of claim 1, further comprising:
a first flat layer interposed between the substrate and the first reflective electrode and between the substrate and the second reflective electrode;
a first lens configured to cover the first reflective electrode on the first flat layer; and
a second lens configured to cover the second reflective electrode on the first flat layer.

4. The display device of claim 3, wherein the first lens is vertically aligned with the first reflective electrode,
wherein the second lens is vertically aligned with the second reflective electrode.

5. The display device of claim 3, wherein a diameter of the first lens is larger than a width of the first reflective electrode,
wherein a diameter of the second lens is larger than a width of the second reflective electrode.

6. The display device of claim 3, further comprising:
a second flat layer configured to cover the first lens and the second lens on the first flat layer; and
a first auxiliary lens and a second auxiliary lens provided on an upper surface of the second flat layer.

7. The display device of claim 6, wherein from a planar viewpoint, a center of the first lens coincides with a center of the first auxiliary lens.

8. The display device of claim 6, wherein the first auxiliary lens is vertically aligned with the first lens,
wherein the second auxiliary lens is vertically aligned with the second lens.

9. The display device of claim 6, wherein a diameter of the first auxiliary lens is smaller than a width of the first reflective electrode,
wherein a diameter of the second auxiliary lens is smaller than a width of the second reflective electrode.

10. The display device of claim 6, wherein a diameter of the first auxiliary lens is smaller than a diameter of the first lens.

11. A display device comprising:
gate lines provided on a substrate having a plurality of pixel areas and extending in a first direction, from a planar viewpoint;
data lines extending in a second direction perpendicular to the first direction and intersecting the gate lines;
reflective electrodes provided inside the pixel areas, respectively;
lenses provided on the reflective electrodes, respectively; and
auxiliary lenses provided on the lenses, respectively,
wherein the gate lines and the data lines define the pixel areas,
wherein the lenses cover the reflective electrodes, respectively,
wherein the auxiliary lenses are vertically aligned with the lenses, respectively.

12. A display device of claim 11, wherein diameters of the lenses are larger than widths of the reflective electrodes, respectively.

13. A display device of claim 11, wherein diameters of the auxiliary lenses are smaller than diameters of the lenses, respectively.

14. The display device of claim 11, wherein the reflective electrodes are spaced apart from the data lines in the first direction,
wherein the reflective electrodes are spaced apart from the gate lines in the second direction,
wherein a distance in which one of the reflective electrodes is spaced apart from one of the data lines in the first direction is different from a distance in which another of the reflective electrodes is spaced apart from another of the data lines in the first direction.

15. The display device of claim 11, wherein a distance in which one of the reflective electrodes is spaced apart from one of the gate lines in the second direction is different from a distance in which another of the reflective electrodes is spaced apart from another of the gate lines in the second direction.
